(19) United States
(12) Patent Application Publication
(10) Pub. No.: US 2015/0142824 A1
(43) Pub. Date: May 21, 2015

(54) Situational Content Based on Context

(71) Applicant: AT&T Mobility II LLC, Atlanta, GA (US)

(72) Inventors: Rick Tipton, Corryton, TN (US); Sheldon Kent Meredith, Mariettta, GA (US); Mark Austin, Roswell, GA (US)

(73) Assignee: AT&T Mobility II LLC, Atlanta, GA (US)

(21) Appl. No.: 14/086,234

(22) Filed: Nov. 21, 2013

(51) Int. Cl. G06F 17/30; H04L 29/08

(52) U.S. Cl. CPC G06F 17/3053; G06F 17/30386; H04L 67/02
USPC 707/748; 707/769

(57) ABSTRACT

Situational awareness is determined to retrieve related content. Historical usage of a mobile device is analyzed to generate a rich mapping of different contexts to different categories of content and other interests. At any time the mapping may be consulted to determine the user's historical interests for the same operational context. Categories of content may then be retrieved and displayed, thus bring forth relevant, contextual content at its moment of need.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Mobile communications have revolutionized our lives. Mobile access to the Internet has put information at our fingertips, at all hours of the day. All this information, however, has become too cumbersome for most of us to manage.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 is a simplified schematic illustrating an environment in which exemplary embodiments may be implemented;

FIG. 2 is a more detailed block diagram illustrating the operating environment, according to exemplary embodiments;

FIG. 3 is a schematic illustrating detection of conditions, according to exemplary embodiments;

FIG. 4 is a schematic illustrating different operational modes, according to exemplary embodiments;

FIG. 5 is a flowchart illustrating a method for determining operational modes, according to exemplary embodiments;

FIG. 6 is a diagram illustrating an alternate scheme for determining the operational modes, according to exemplary embodiments;

FIG. 7 is a schematic illustrating social networking, according to exemplary embodiments;

FIG. 8 is a schematic illustrating categorization, according to exemplary embodiments;

FIGS. 9-10 are schematics illustrating a matrix of selections, according to exemplary embodiments;

FIG. 11 is a schematic illustrating categorical queries, according to exemplary embodiments; and

FIGS. 12-13 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

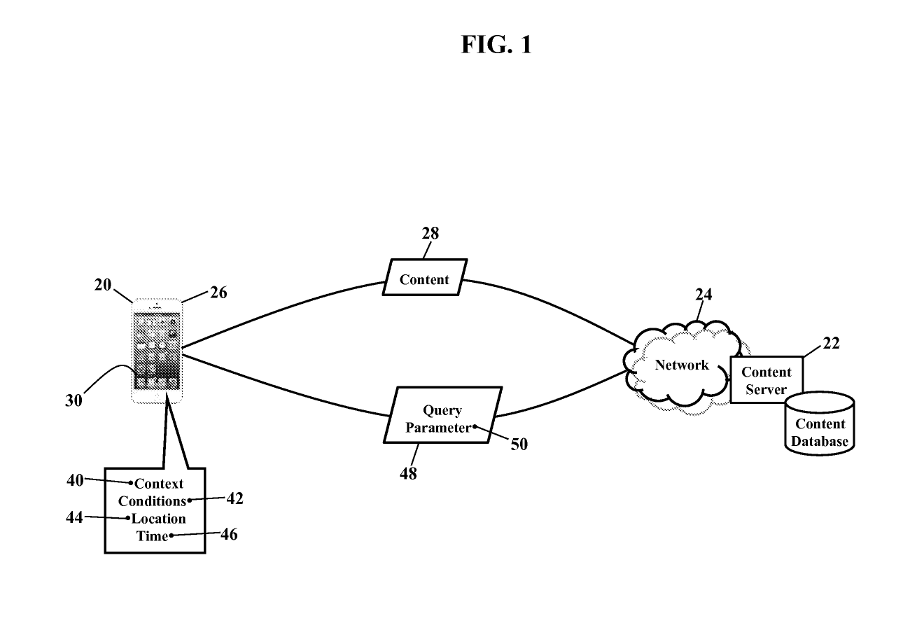

FIG. 1 is a simplified schematic illustrating an environment in which exemplary embodiments may be implemented. FIG. 1 illustrates a mobile device 20 communicating with a content server 22 using a communications network 24. The mobile device 20, for simplicity, is illustrated as a smartphone 26, but the mobile device 20 may be any mobile or stationary processor-controlled device (as later paragraphs will explain). The mobile device 20 processes content 28 for display on a display device 30.

Here, though, the content 28 is relevant to context 40. As the mobile device 20 is carried and used throughout the day, various conditions 42 change. The conditions 42 may determine the current situational context 40 of the mobile device 20. The conditions 42, for example, may include location 44 and time 46 that the mobile device 20 is currently being used. However, there may be many other conditions 42 for determining the context 40, which later paragraphs will explain. The conditions 42 are evaluated to determine the context 40. Once the context 40 is determined, exemplary embodiments may then send a query 48 for the content 28 that is related to the context 40. The query 48 is sent to a network address that is assigned to the content server 22. The query 48 includes one or more query parameters 50 that are related to the context 40. The content server 22 retrieves the content 28 that is related to the query parameter(s) 50. The content 28, in other words, is relevant to the user's situation, location, schedule, and interests. The content 28 is sent to the network address of the mobile device 20 and displayed on the display device 30. Exemplary embodiments thus automatically sense the user's current situation and query for relevant information. The user need not “mine” the mobile device 20 nor search the Internet. Relevant information, in simple terms, is automatically and effortlessly displayed when and where it is needed.

Exemplary embodiments may even anticipate the user's needs. As the user gains experience with the mobile device 20, the mobile device 20 may recognize recurring patterns of use. The location 44 and the time 46, for example, are just some of the conditions 42 that may be used to distinguish between work, home, and travel usage patterns. The context 40 likely differs between morning, afternoon, evening, and holiday hours. The location 44 and the time 46 may be used to determine other contexts 40, such as shopping, business, entertainment, vacation, and leisure activities. Indeed, as the mobile device 20 is used over time, daily habits emerge for predicting the user's informational needs. Once the context 40 is determined, exemplary embodiments may retrieve useful, relevant, and timely content 28 on the user's behalf. Indeed, exemplary embodiments may even switch operational modes (such as opening software applications) that are habitually used in the same context 40. Exemplary embodiments may thus anticipate the user's needs, based on the context 40.

A few examples help explain the related content 28. When the location 44 and time 46 indicate a home context 40, the mobile device 20 may prioritize and display home-related tasks and interests (such as evening entertainment options). Indeed, the mobile device 20 may even switch to a habitual mode of operation, such as automatically opening a NETFLIX® streaming application at 8 PM. When a weekend context 40 is determined, upcoming local concerts and sporting events may be retrieved and displayed, based on historical interests in these categories of content. Show times of movies may be retrieved and displayed, based on categorical preferences. Weekend chores may be automatically retrieved and displayed. When a work context 40 is determined, the mobile device 20 may prioritize applications with business contacts, meetings, and news. Work-related tasks may bubble up for display, along with meeting schedule from the day's calendar. Traffic maps may be automatically displayed to help with morning and evening commutes. If a travel context 40 is determined, weather information and flight schedules may be automatically retrieved. An airline tracker application may be opened to display a flight status. If a vacation context 40 is determined, searches for local interests may be automatically performed. In short, whatever the context 40, the mobile device 20 may assume modes of operation and retrieve the related content 28.

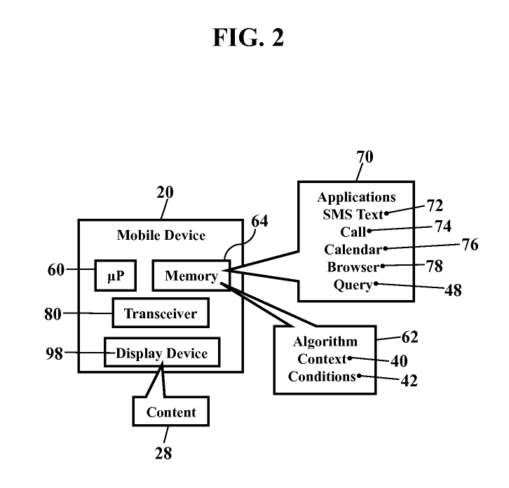

FIG. 2 is a more detailed block diagram illustrating the operating environment, according to exemplary embodiments. The mobile device 20 may have a processor 60 (e.g., “μP”), application specific integrated circuit (ASIC), or other component that executes an algorithm 62 stored in a local memory 64. The memory 64 may also store different software applications 70 (such as an SMS texting application 72, a call application 74, a calendar application 76, and a web browser application 78). The algorithm 62 has instructions, code, and/or programs that may cause the processor 60 to determine the context 40 from the conditions 42. Once the context 40 is determined, the algorithm 62 may instruct any of the software applications 70 to open or execute in response to the context 40. The algorithm 62, for example, may instruct the processor 60 to call the web browser application 78 and to generate the query 48 related to the context 40. The processor 60 may instruct a transceiver 80 to transmit the query 48 to the network address of the content server (illustrated as reference numeral 22 in FIG. 1). The related content 28 is locally and/or remotely retrieved. The algorithm 62 then instructs the processor 60 to process the related content 28 for display on the display device 30. The algorithm 62 thus automatically determined the user's current context 40 and retrieved the relevant content 28. The algorithm 62 thus automatically brings forth whatever the content 28 to suit the user's current context 40.

Exemplary embodiments may be applied regardless of networking environment. Exemplary embodiments may be easily adapted to mobile devices having cellular, WI-FI®, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. The processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations”, this could include the processor performing the operations directly and/or facilitating, directing, or cooperating with another device or component to perform the operations.

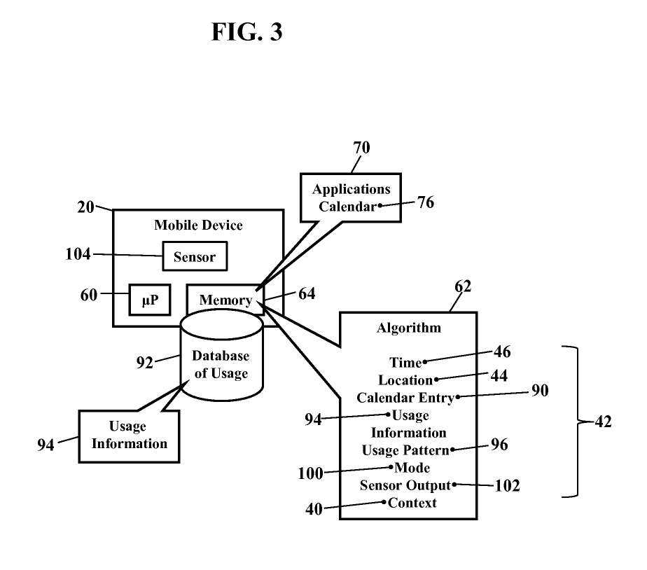

FIG. 3 is a schematic illustrating detection of the conditions 42, according to exemplary embodiments. Whenever the mobile device 20 is powered on, the algorithm 62 may obtain the time 46 of day and the current location 44. The algorithm 62 may retrieve one or more entries 90 in the user's electronic calendar application 76. A database 92 of usage may also be stored and queried for usage information 94 historically observed or logged at the time 46 of day and at the current location 44. The database 92 of usage thus stores the usage information 94 describing how the mobile device 20 has been operated at different times 46 and locations 44. Over time, then, the database 92 of usage reveals repeated, habitual usage as one or more historical usage patterns 96. As the reader likely knows, the smartphone (illustrated as reference numeral 26 in FIG. 1) may store and execute many different software applications 70. Each specific software application 70 may only be used during a subset of the conditions 42. The database 92 of usage may thus reveal the dates, times, and locations at which certain ones of the software applications 70 are used. Exemplary embodiments, then, detect the conditions 42 in which the mobile device 20 and/or any of the software applications 70 are used.

The database 92 of usage may be simple or elaborate. As the mobile device 20 is used, the algorithm 62 may log and store the usage information 94. The algorithm 62, for example, may observe and record which software applications 70 are used for any combination of the conditions 42 (e.g., the time 46 of day and the location 44). Over time the algorithm 62 learns which ones of the software applications 70 are used most often for different combinations of the conditions 42. The algorithm 62 may thus tally the usage information 94 and learn what software applications 70 the user prefers for the different conditions 42. For example, the algorithm 62 may monitor how often each software application 30 is started, how often each software application 30 is open, what calls are placed, and to whom texts are sent. The algorithm 62 thus logs the usage information 94 during different operational modes 100 of the mobile device 20.

Sensor outputs 102 may also be obtained. As the reader may know, many mobile devices 20 have many sensors 104 for additional detection of the conditions 42. A global positioning system (or “GPS”) module may provide the time 46 of day and the current location 44. The time 46 may be determined from a clock signal, from a network signal, or from any known method. The time 46 may also be retrieved from the calendar application 76. However the time 46 is retrieved, the time 46 may be expressed along with the current day, month, and year. An accelerometer may provide measurements or signals representing acceleration. The location 44 may be alternatively determined from WI-FI® access points, network identifiers, and/or any known method. The sensor 104 may provide some information indicating temperature, altitude, pressure, humidity, and any other ambient condition 42. The sensor 104 may also include output from a microphone, thus providing audible conditions 42 as inputs to the algorithm 62.

The time 46 and the location 44 may be adaptively combined. The algorithm 62 may determine the mobile device 20 is currently at the “home” location 44 based on detection of a known home location 44 or a known residential network, perhaps along with morning or night hours. A “work” location 44 may be determined from detection of an office location or network, perhaps along with weekday daytime hours (e.g., 9 AM to 5 PM). A “weekend” context 40 may be simply inferred from a Saturday or Sunday date. The algorithm 62 may also generate a prompt on the display device 30, asking the user to confirm or input the time 46 and/or the location 44.

The context 40 may be further defined. Movement, especially at high rates of change, may indicate a “travel” context 40. The date and time may also be related to a “seasonal” context 40, such as winter and/or holidays. The time 46, the location 44, and entries 90 in the user's electronic calendar application 76 may also be used to infer other contexts 40, such as “morning” and “afternoon,” “business,” “entertainment,” and “vacation.” The conditions 42 may define other contexts 40, such as “leisure” and “shopping.” Exemplary embodiments may define any number or combination of the different contexts 40, based on any one or combination of the conditions 42.

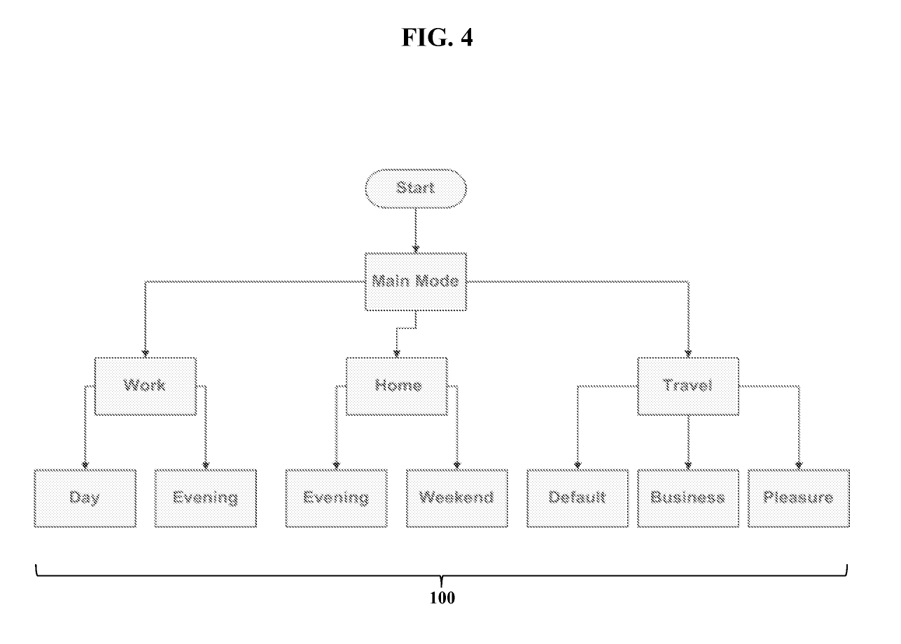

FIG. 4 is a schematic illustrating different operational modes 100, according to exemplary embodiments. FIG. 4, for simplicity, only illustrates several common modes 100 that may be determined from the conditions (illustrated as reference numeral 42 in FIG. 3). In practice, though, exemplary embodiments may determine many different operational modes 100. Regardless, once the algorithm 62 determines the one or more conditions 42, the algorithm 62 determines the current operational mode 100 for the mobile device 20. That is, the algorithm 62 analyzes the conditions 42 (e.g., the time 46 of day, the location 44, the entries 90 in the electronic calendar application 76) and concludes how best to characterize the operational mode 100 for the mobile device 20. FIG. 4 thus illustrates only several different operational modes 100, such as “work,” “home,” and “travel.” Each operational mode 100 may be further, hierarchically defined with sub-tiers or levels, such as “day” or “evening” for the “work” mode 100. The “home” mode 100 may be further defined as “evening” or “weekend,” while the “travel” mode 100 may also have sub-categorizations.

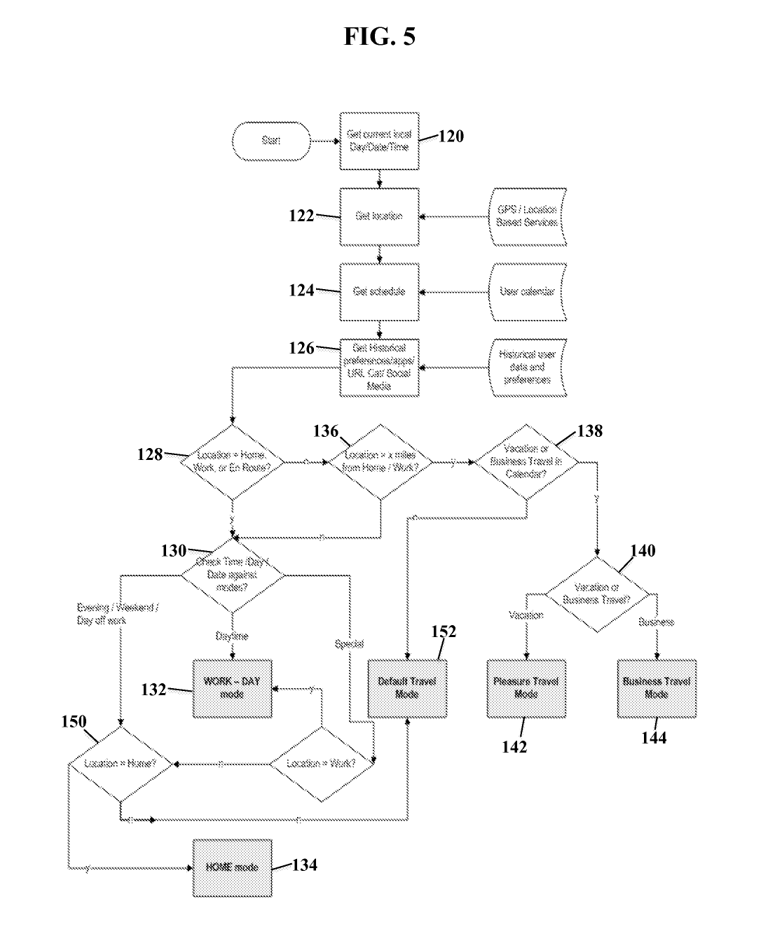

FIG. 5 is a flowchart illustrating a method of the algorithm 62 for determining the operational modes 100, according to exemplary embodiments. The current time 46 (Block 120) and location 44 (Block 122) are acquired. The entries 90 in the user's electronic calendar application 76 are acquired (Block 124). The historical usage pattern 96 is retrieved (Block 126) from the database 92 of usage. The historical usage pattern 96 reveals the user's preferences, if any, for the same location 44 and time 46. Decisions are made as to whether the current location 44 matches known locations for work, home, or daily routes (Block 128). If a locational match is determined (Block 128), the current time 46 may differentiate (Block 130) between the work mode (Block 132) and the home mode (Block 134). If the current location 44 fails to match the known locations for work, home, or daily routes (Block 128), then the current location 44 is compared to a threshold distance from the known work or home locations (Block 136). If the threshold distance is exceeded (Block 136), then the user's electronic calendar application 76 is queried for the current location 44 and time 46 (Block 138). A match between the calendar entry 90 and the current location 44 and time 46 (Block 140) may thus differentiate between a pleasure travel mode (Block 142) and a business travel mode (Block 144).

As FIG. 5 illustrates, defaults may also be assumed. For example, if the current time 46 is historically home or weekend hours (Block 130), but the location 44 fails to match the known home location 44 (Block 150), then a default travel mode (Block 152) may be defined. Similarly, if the current location 44 fails to match known work, home, or commuting routes (Block 128), the threshold distance is exceeded (Block 136), but there are no matches to the user's electronic calendar 76 (Block 138), then the default travel mode (Block 152) may be defined.

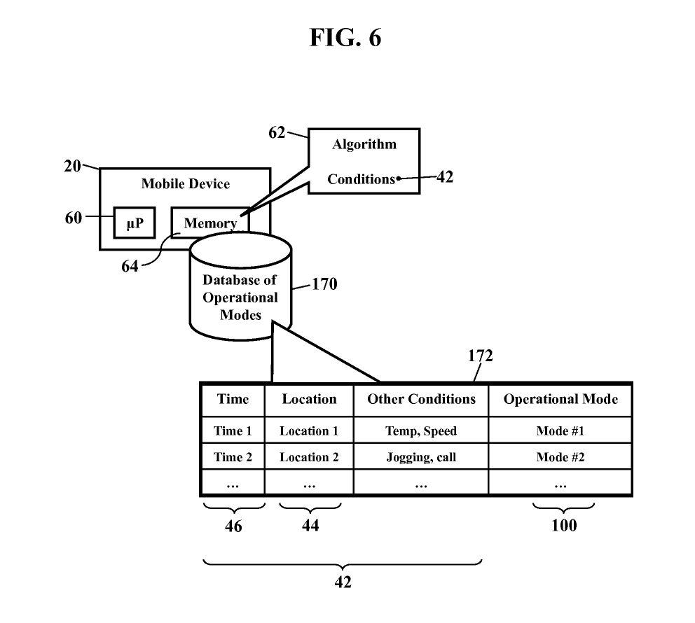

FIG. 6 is a diagram illustrating an alternate scheme for determining the different modes 100 of operation, according to exemplary embodiments. Instead of a decision analysis (as FIG. 5 illustrates), here the different operational modes 100 may be stored in a database 170 of operational modes. FIG. 6, for example, illustrates the database 170 of operational modes as a table 172 that maps, relates, or associates different combinations of the conditions 42 to different operational modes 100. The database 170 of operational modes may thus be populated with entries for many different combinations of the conditions 42 and their corresponding operational modes 100. While FIG. 6 only illustrates a few entries, in practice the database 170 of operational modes may contain hundreds, perhaps thousands, of entries. There may thus be many operational modes 100, depending on how the conditions 42 are categorized, valued, or delineated. Once the algorithm 62 determines the conditions 42, the algorithm 62 may query the database 170 of operational modes for the conditions 42. If the conditions 42 match one of the entries in the database 170 of operational modes, the algorithm 62 may retrieve the corresponding operational mode 100.

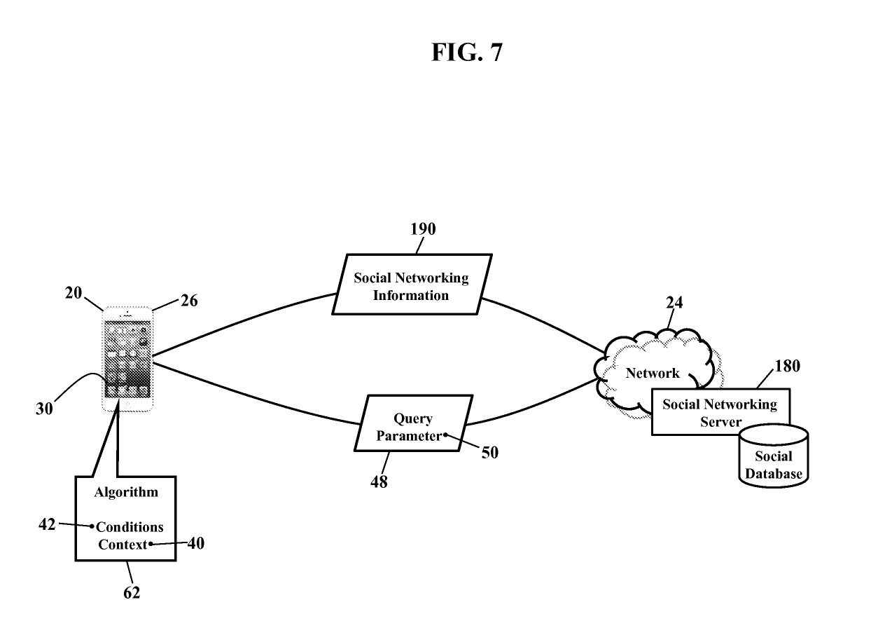

FIG. 7 is a schematic illustrating social networking, according to exemplary embodiments. As the algorithm 62 gains experience with the user, the algorithm 62 may also consult the user's social networks to help determine the context 40. FIG. 7, for example, again illustrates the query 48 sent from the user's mobile smartphone 26. Here, though, the query 48 may be sent to the network address of a social networking server 180. The user may have one or more social networking accounts, such as FACEBOOK®, LINKEDIN®, TWITTER®, INSTAGRAM®, and any other. The query 48 may have the parameter 50 representing any of the conditions 42 associated with the mobile device 20 (such as the smartphone 26). When the social networking server 180 receives the query 48, the social networking server 180 may retrieve any social networking information 190 that matches the parameter 50. The social networking server 180 sends the social networking information 190 to the network address of the mobile device 20. The algorithm 62 may then store and evaluate the social networking information 190 when determining the context 40.

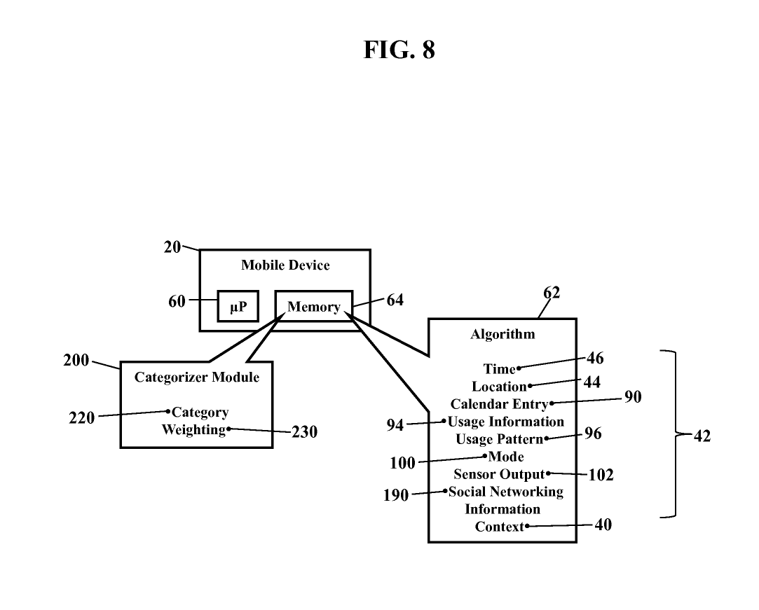

FIG. 8 is a schematic illustrating categorization, according to exemplary embodiments. As the user experiences the algorithm 62, the algorithm 62 may have a large amount of data from which to determine the context 40. The algorithm 62, for example, will have the various conditions 42. The algorithm 62 will have the user's social networking information 190, such as posts and messages to the user's social network. The algorithm 62 will also have the historical usage pattern 96 describing the user's habitual usage information 94 at similar conditions 42. The algorithm 62 may thus have a plethora of data from which to retrieve any related content 28.

The analysis, however, may be streamlined. The amount of data available to the algorithm 62 may be large. Indeed, over time the data may become too large to efficiently manage. Exemplary embodiments, then, may call or invoke a categorizer module 200. The categorizer module 200 is a software application, routine, or service that categorizes information into uniform or standard categories 220. The algorithm 62, for example, may instruct the processor 60 to execute the categorizer module 200 and to assign one or more categories 220 to the conditions 42. The categorizer module 200, for example, may assign a category 220 to the user's posts, messages, and other social networking information 190. The categorizer module 200 may also categorize any of the usage information 94 and/or the historical usage pattern 96. The categorizer module 200 may similarly categorize any of the conditions 42. As many of the conditions 42 may match multiple categories 220, the categorizer module 200 may also determine or assign a weighting 230 to each separate category 220. The algorithm 62 thus may only process the different categories 220 and weightings 230 to save time and processing resources.

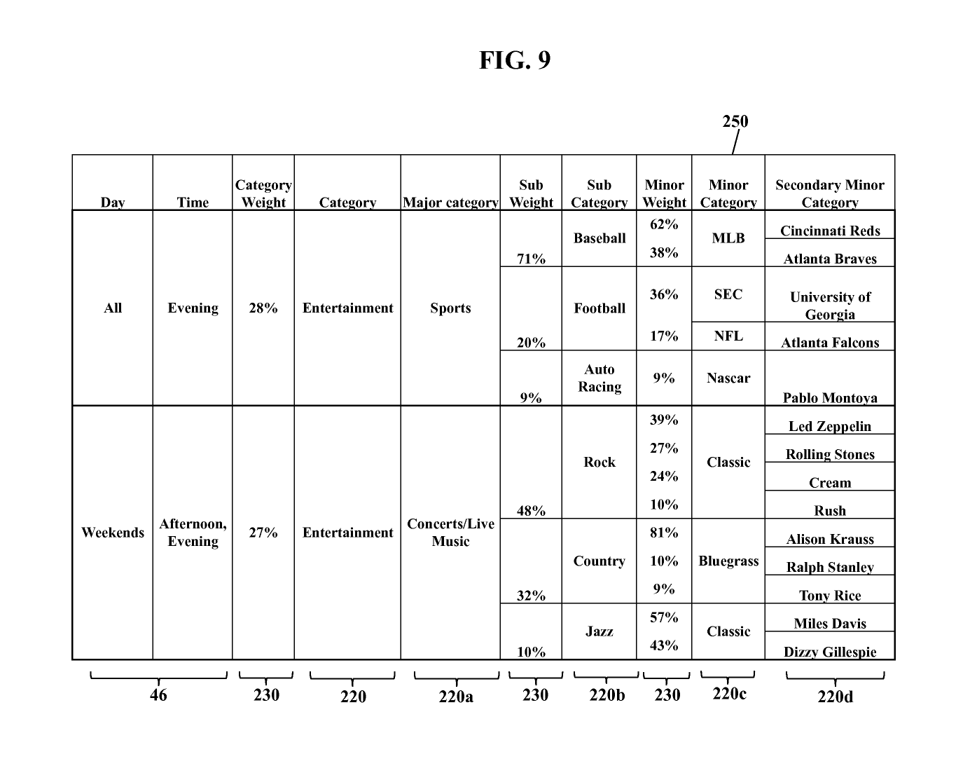

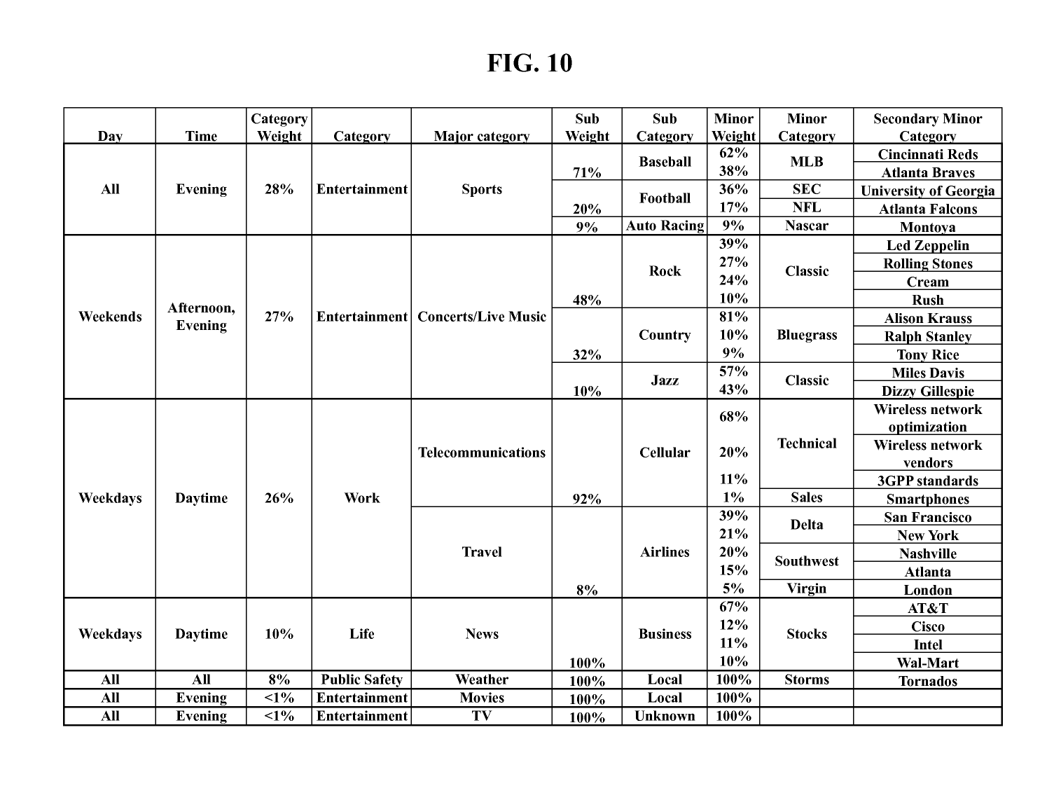

FIGS. 9-10 are schematics illustrating a matrix 250 of selections, according to exemplary embodiments. As the algorithm 62 matures with time, the algorithm 62 generates the matrix 250 of selections to help select the query parameter for the related content (illustrated, respectively, as reference numerals 50 and 28 in FIGS. 1 and 7). The matrix 250 of selections, in other words, help determine what related content 28 would be most useful to the user, given the context 40. The algorithm 62 selects the query parameter 50, perhaps based on the weightings 230 of the different categories 220 in the matrix 250 of selections. That is, the matrix 250 of selections provides a map of appealing categories 220, based on the weighting 230, for different contexts 40. Once the context 40 is determined, the matrix 250 of selections may be queried for the matching context 40. The categories 220 of content related to the context 40 may then be retrieved. Should more than one category 220 be related to the context 40, then the weighting 230 of the different categories 220 may be further used as prioritization.

The matrix 250 of selections thus represents the user's preferences during any context 40. The weightings 230 may be based on counts of usages and/or the duration of use for any of the applications (illustrated as reference numeral 70 in FIG. 2). The weightings 230 may also be based on counts of topical searches for Internet content (as determined from the different historical queries logged in the database 92 of usage). Similar categories 220 may be associated with other like data from different sources to calculate the weightings 230. For example, websites visited for baseball scores may be categorically associated with online purchases of tickets to baseball games, time spent watching highlights of baseball games, and games attended that were scheduled in the user's electronic calendar (illustrated as reference numeral 76 in FIG. 2).

Weightings 230 may be calculated for hierarchical categories. As FIG. 9 illustrates, the categorization may reveal a top-level category 220 with sub-level categorizations (such as a major category 220a, a sub-category 220b, a minor category 220c, and a secondary minor category 220d). The weightings 230 may also consider the time spent within different hierarchical categories 220, out of a total time available. Categories may be hierarchical, in that a major category may start with a default weighting in different time slots (e.g., Morning, Evening, Daytime, and Weekend). The weightings 230, though, may change as the user's habits on the mobile device 20 are detected and calculated (such as Work, Home, Entertainment, Life Events, and Travel). Any sub-categories and minor categories within the major categories may start with a default weighting 230 of zero (0). Weightings may then increase as the topical occurrences increase in frequency. Any Minor Categories may be collected from user actions and added to other categories (such as sports teams, cities traveled, and music interests). As time passes and experience grows, the matrix 250 of selections will mature and become more accurate in time and content.

FIG. 9 thus illustrates only a sample view of the matrix 250 of selections. FIG. 9, for simplicity, only illustrates a few major “Entertainment” categories 220 for different days and times. The user's “entertainment” categories 220 may have hierarchical major categories 220a of “sports” and “music.” The user's affinity for “sports” may be further sub-categorized into different types of sports 220b and 220c and different teams 220d within each type of sport. Similarly, her love of music 220a may be sub-categorized into different genres 220b and 220c and finally down to different artists 220d. Each different category 220 may have its corresponding weighting 230.

Some examples further explain FIG. 9. Suppose the user visits baseball websites an average of 4.7 times daily to check scores and highlights. Her electronic calendar application 76 and/or her historical usage pattern 96 may reveal that she attends ATLANTA BRAVES® games an average of 3.3 times per month. Her online purchase records (also from her historical usage pattern 96) may reveal that she also purchased a CINCINNATI REDS® baseball cap from www.MLB.com. Her historical usage pattern 96 may also indicate that she bought tickets to four (4) ATLANTA BRAVES®, with three (3) of those games against the CINCINNATI REDS®. Perhaps her social networking information 190 also revealed that she “Liked” the ATLANTA BRAVES® on FACEBOOK®. The common categories 220, of course, are “Entertainment,” “Sports,” and “Baseball.” All this usage information 94 may be weighted against her other current and historical usage information.

Her interests may be further defined. Suppose her historical usage pattern 96 also reveals that she purchased classic rock songs from ITUNES®, that she listens to PANDORA®, and that she purchased tickets to several music events. A detailed analysis may indicate that she listens to PANDORA® an average of 3.2 hours daily, that her calendar lists an average of 2.1 live music events attended per month, and that she downloads an average of 6.9 songs per month of various artists. Moreover, she “Liked” various artists on her social networking sites.

The user's preferences thus emphasize the “Entertainment” category 220. Her activities may be weighted against all other “Entertainment” items in the category based on time spent, number of hits, number of live events attended, or any other measure. Her activities may thus be scored according to their value to a particular category 220. For instance, attending an event or purchasing a related item may be worth more “points” than merely web surfing. A sample scoring system, for example, may be as follows:
time surfing a particular subject is worth 1 point per hour;
time attending the particular subject is worth 5 points per instance and 1 point per hour;
purchases related to the particular subject are worth 5 points each; and
social networking “Likes” are worth 2 points each.
   Numerous other points may be assigned to different activities. Regardless, the categorical points may be summed and weighted, per each hierarchical category 220, according to the percentage of total score for the entire category. Based on the scoring calculations, FIG. 9 thus illustrates the weighting for the user's different hierarchical “Entertainment” categories. Relevance to the user may then be determined by their respective weightings 230 in the main category and sub-minor-secondary categories.

FIG. 10 illustrates a fuller, more mature matrix 250 of selections. As this disclosure explains, over time the algorithm 62 will learn the user's preferences for different contexts 40. At different times of different days, the user may thus have many different categories 220 of usage information 94 in her historical usage pattern 96. The algorithm 62 may thus generate a richer categorical description of her preferences for different contexts 40. Once the user's context 40 is confidently predicted, the matrix 250 of selections maps the relevant, weighted categories 220 of information that are historically seen for the same context 40.

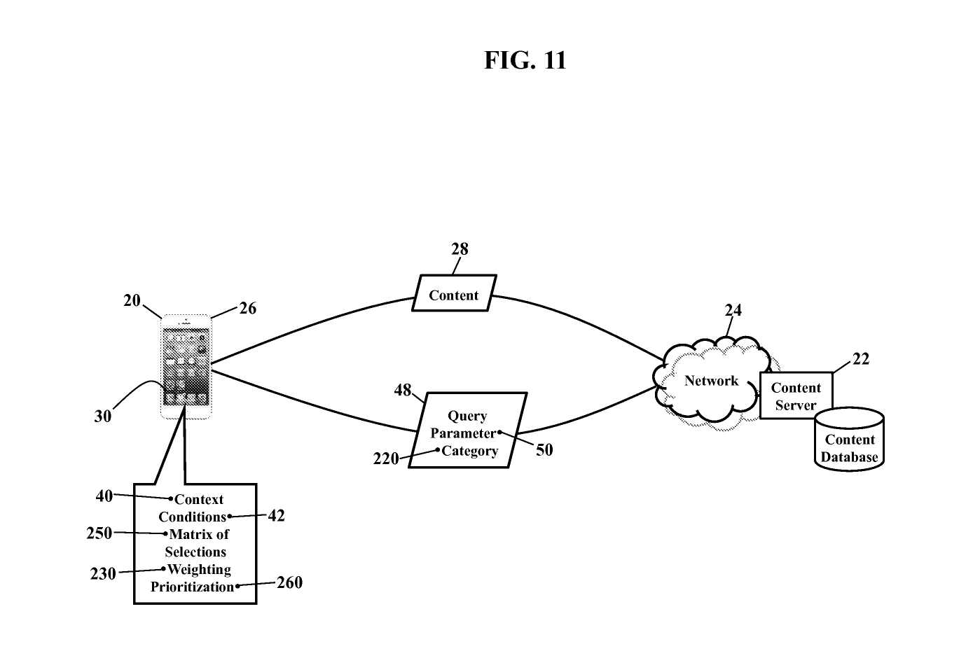

FIG. 11 is a schematic illustrating categorical queries, according to exemplary embodiments. The context 40 is determined, and the matrix 250 of selections is generated, as the above paragraphs explain. The algorithm 62 queries the matrix 250 of selections for the context 40 and retrieves one or more of the categories 220 associated to the context 40. The algorithm 62 may then cause the mobile device 20 to generate the query 48 having the query parameter 50 matching the mapped category 220. If multiple, hierarchical categories 220 map to the same context 40, then the algorithm 62 may send multiple queries 48, with each query 48 requesting a different one of the topical categories 220. The algorithm 62 may implement a prioritization 260 in which the multiple queries 48 are sent in sequential order, based on the hierarchical category 220 and the respective weighting 230. Referring back to FIG. 10, a query 48 for “Cincinnati Reds” (at 71% and 62%, respectively) may be first sent during all daily evening times, followed by a query for “Atlanta Braves” (at 71% and 38%, respectively). In other words, exemplary embodiments may first query for the highest weightings 230 in each hierarchical, categorical arrangement to the “Secondary Minor Category.” Queries for lesser weightings may follow.

Exemplary embodiments thus seek and retrieve contextually relevant content 28. As the algorithm 62 gains experience, the algorithm 62 will recognize recurring patterns of use during work, home, and other contexts 40. The algorithm 62 will further learn the user's preferences during morning, afternoon, evening, and holiday hours. In time the algorithm 62 will anticipate the user's informational needs, thus searching and retrieving relevant content for the context 40.

Sometimes the related content 28 may be too great to simultaneously display. Should multiple categories 220 match to the same context 40, the algorithm 62 may implement the prioritization 260. That is, the algorithm 62 may prioritize the order in which the matching categories 220 are searched. The prioritization 260, however, may also apply to processing and display of the related content 28. Higher weighted categories 220 of content, for example, may be first processed and displayed (e.g., the query results for “Cincinnati Reds” may be processed and displayed prior to the query results for “Atlanta Braves”).

The prioritization 260, however, may also be based on the display device 30. The mobile smartphone 26, as we all know, may have a small screen on which a limited amount of the content 28 may be displayed. Whatever the available display area on the display device 30, the prioritization 260 may assign a display area to the different categories 220 associated with the context 40. Each different category 220 mapped to the context 40, in other words, may be assigned a proportional portion of the display screen 30. Proportionality may even be assigned to the weighting 230 of the category 220. Again referring back to FIG. 10, the search results for “Cincinnati Reds” may be proportionally sized to consume no more than 62% of the available area of the display device 30. Similarly, the related content 28 for “Atlanta Braves” may be sized at no more than 38% of the pixel resolution. The prioritization 260 may reflect higher categorical levels, such as 71% of the display device 30 may be dedicated to search results for “Baseball,” while 20% and 9% of the screen are reserved, respectively, for “Football” and “Auto Racing” search results. The “sub-category” weights 230 would ensure the user's informational needs are met during the “evening” contextual hours.

Exemplary embodiments thus generate situational awareness. The algorithm 62 understands what user is doing at the location 44 and the time 46. The algorithm 62 retrieves and conditions 42 and queries multiple data sources to make intelligent decisions in the user's interests. The algorithm 62 senses the user's current situation, switches to the appropriate mode 100, and “bubbles up” the most relevant content 28 to user.

Exemplary embodiments my also be remotely or centrally processed. The conditions 42, for example, may be uploaded to a central server for analysis. The database 92 of usage may be remotely stored and maintained at any network location. The matrix 250 of selection may also be remotely generated, perhaps by the same central server. The matrix 250 of selection may then be downloaded to the mobile device 20, or the algorithm 62 may send queries to the central server specifying its current context 40. Indeed, the exemplary embodiments may be performed as a cloud-based service.

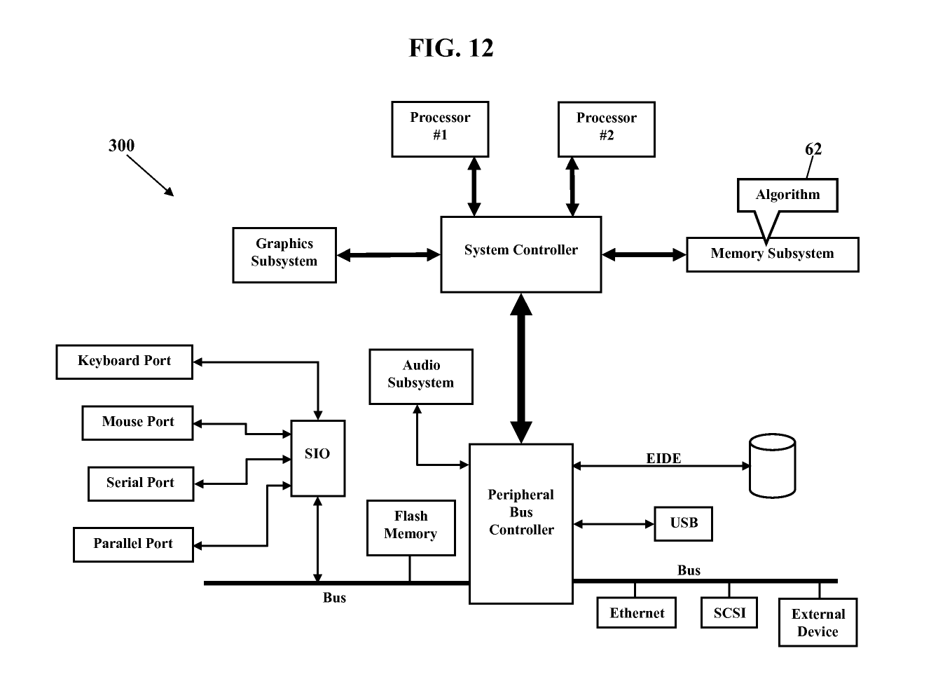

FIG. 12 is a schematic illustrating still more exemplary embodiments. FIG. 12 is a more detailed diagram illustrating a processor-controlled device 300. As earlier paragraphs explained, the algorithm 62 may operate in any processor-controlled device. FIG. 12, then, illustrates the algorithm 62 stored in a memory subsystem of the processor-controlled device 300. One or more processors communicate with the memory subsystem and execute either, some, or all applications. Because the processor-controlled device 300 is well known to those of ordinary skill in the art, no further explanation is needed.

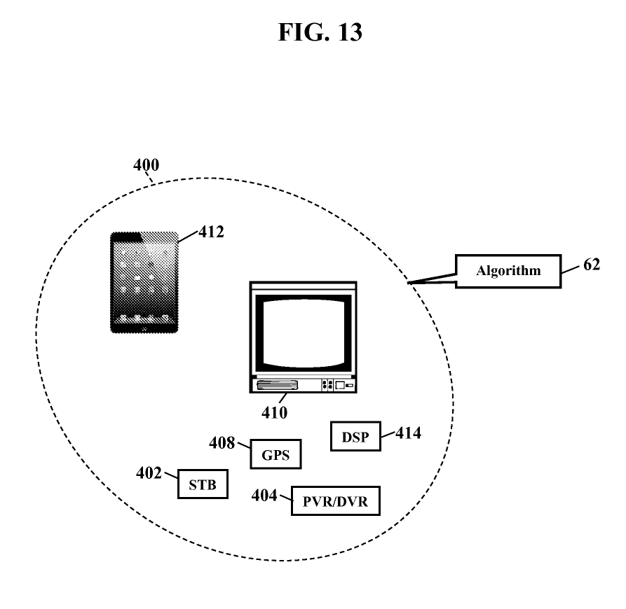

FIG. 13 depicts other possible operating environments for additional aspects of the exemplary embodiments. FIG. 13 illustrates the algorithm 62 operating within various other devices 400. FIG. 13, for example, illustrates that the algorithm 62 may entirely or partially operate within a set-top box (“STB”) (402), a personal/digital video recorder (PVR/DVR) 404, a Global Positioning System (GPS) device 408, an interactive television 410, a tablet computer 412, or any computer system, communications device, or processor-controlled device utilizing the processor 60 and/or a digital signal processor (DP/DSP) 414. The device 400 may also include watches, radios, vehicle electronics, clocks, printers, gateways, mobile/implantable medical devices, and other apparatuses and systems. Because the architecture and operating principles of the various devices 400 are well known, the hardware and software componentry of the various devices 400 are not further shown and described.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for retrieving situational content, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method, comprising:
determining a context associated with a time and a location of a mobile device;
storing in memory a matrix of selections that maps different contexts of the mobile device to different categories of historical usage of the mobile device;
querying the matrix of selections for the context associated with the time and the location of the mobile device;
retrieving one of the different categories of the historical usage that matches the context in the matrix of selections;
sending a search query from the mobile device, the search query having the one of the different categories of the historical usage as a query parameter;
receiving a search result of the query; and
displaying the search result at the mobile device in response to the context.

2. The method of claim 1, further comprising retrieving multiple ones of the different categories of the historical usage that match the context in the matrix of selections.

3. The method of claim 2, further comprising prioritizing multiple search queries for the multiple ones of the different categories according to a weighting assigned to each category in the multiple ones of the different categories.

4. The method of claim 1, further comprising matching the query parameter to the one of the different categories of the historical usage retrieved from the matrix of selections.

5. The method of claim 1, further comprising instructing a web browser application to generate the search query having the one of the different categories of the historical usage as the query parameter.

6. The method of claim 1, further comprising determining an operational mode of the mobile device.

7. The method of claim 1, further comprising querying for social networking information related to the time and the location of the mobile device.

8. A system, comprising:
a processor; and
a memory storing instructions that when executed cause the processor to perform operations, the operations comprising:
determining a context associated with a time and a location;
storing a matrix of selections that maps different contexts to different categories of historical usage;
querying the matrix of selections for the context associated with the time and the location;
retrieving one of the different categories of the historical usage that matches the context in the matrix of selections;
sending a search query having the one of the different categories of the historical usage as a query parameter;
receiving a search result of the query; and
displaying the search result in response to the context.

9. The system of claim 8, wherein the operations further comprise retrieving multiple ones of the different categories of the historical usage that match the context in the matrix of selections.

10. The system of claim 9, wherein the operations further comprise prioritizing multiple search queries for the multiple ones of the different categories according to a weighting assigned to each category in the multiple ones of the different categories.

11. The system of claim 8, wherein the operations further comprise matching the query parameter to the one of the different categories of the historical usage retrieved from the matrix of selections.

12. The system of claim 8, wherein the operations further comprise instructing a web browser application to generate the search query having the one of the different categories of the historical usage as the query parameter.

13. The system of claim 8, wherein the operations further comprise determining an operational mode.

14. The system of claim 8, wherein the operations further comprise querying for social networking information related to the time and the location.

15. A memory storing instructions that when executed cause a processor to perform operations, the operations comprising:
determining a context associated with a time and a location of a mobile device;
storing in memory a matrix of selections that maps different contexts of the mobile device to different categories of historical usage of the mobile device;
querying the matrix of selections for the context associated with the time and the location of the mobile device;
retrieving one of the different categories of the historical usage that matches the context in the matrix of selections;
sending a search query from the mobile device, the search query having the one of the different categories of the historical usage as a query parameter;
receiving a search result of the query; and
displaying the search result at the mobile device in response to the context.

16. The memory of claim 15, wherein the operations further comprise retrieving multiple ones of the different categories of the historical usage that match the context in the matrix of selections.

17. The memory of claim 16, wherein the operations further comprise prioritizing multiple search queries for the multiple ones of the different categories according to a weighting assigned to each category in the multiple ones of the different categories.

18. The memory of claim 15, wherein the operations further comprise matching the query parameter to the one of the different categories of the historical usage retrieved from the matrix of selections.

19. The memory of claim 15, wherein the operations further comprise instructing a web browser application to generate the search query having the one of the different categories of the historical usage as the query parameter.

20. The memory of claim 15, wherein the operations further comprise querying for social networking information related to the time and the location.
